(19) United States
(12) Patent Application Publication
(10) Pub. No.: US 2014/0019193 A1
(43) Pub. Date: Jan. 16, 2014

(54) Issue Processing Systems and Methods

(71) Applicants: Holger Ulrich Eisele, Walldorf (DE); Ingo Panchyrz, Walldorf (DE); Beate Lindqvist, Walldorf (DE)

(72) Inventors: Holger Ulrich Eisele, Walldorf (DE); Ingo Panchyrz, Walldorf (DE); Beate Lindqvist, Walldorf (DE)

(73) Assignee: SAP AG, Walldorf (DE)

(21) Appl. No.: 13/545,754

(22) Filed: Jul. 10, 2012

(51) Int. Cl. G06Q 10/06

(52) U.S. Cl. CPC G06Q 10/0635
USPC 705/7.28

(57) ABSTRACT

Example issue processing systems and methods are described. In one implementation, a method identifies an issue and accesses rules related to resolving the issue. The method also accesses data associated with previous issue resolutions. The identified issue is analyzed based on the rules and data associated with previous issue resolutions. Based on the analysis, the method determines a first activity to perform and identifies the results of performing the first activity. If the first activity did not resolve the issue, the method further analyzes the issue based on the rules, the data associated with previous issue resolutions, and the results of performing the first activity. Based on this further analysis, the method determines a second activity to perform in an attempt to resolve the issue.

### FIELD

The present disclosure relates generally to handling issues and, more specifically, to identifying activities that may assist in resolving issues.

### BACKGROUND

Most entities and organizations face issues during normal day-to-day operations. Issues may include quality-related issues, product complaints, or customer service issues. These entities and organizations typically want to resolve issues to improve customer relations, improve business operations, and solve quality-related problems.

### BRIEF DESCRIPTION OF THE DRAWINGS

The present disclosure is illustrated by way of example and not limitation in the figures of the accompanying drawings, in which like references indicate similar elements.

FIG. 1 is a block diagram of an example system having a client-server architecture for an enterprise application platform capable of employing the systems and methods described herein.

FIG. 2 is a block diagram of example applications and modules employable in the enterprise application platform of FIG. 1.

FIG. 3 is a block diagram of example applications and modules utilized in the enterprise application platform of FIG. 1 for issue processing.

FIGS. 4A and 4B represent a flow diagram of an example method of defining and applying rules related to one or more issues.

FIG. 5 is a flow diagram of an example method of analyzing an issue.

FIGS. 6-8 illustrate example user interfaces enabling a display of, and interaction with, various aspects of an issue processing system.

FIG. 9 depicts a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

At least some of the embodiments described herein provide various techniques for processing issues based on one or more rules or other information. As used herein, an issue includes any type of event, activity, exception, problem, and the like that occurs with an individual, a system or an entity. Example issues include customer complaints, manufacturing issues, delivery issues, customer service problems, and the like.

The systems and methods described herein support the processing of issues in an attempt to resolve the issues. In some embodiments, multiple activities or questions are applied to obtain data that is useful in resolving the issue. These activities or questions are determined, at least in part, based on business rules, previous resolution of similar issues, and the like. In some embodiments, the activities include corrective, preventive, and immediate activities. Although an issue may be triggered by one application, the activities used to resolve the issue can be related to a different application. Issues and activities may be associated with any type of application, such as shipping applications, material management applications, batch management applications, customer applications, vendor applications, and the like.

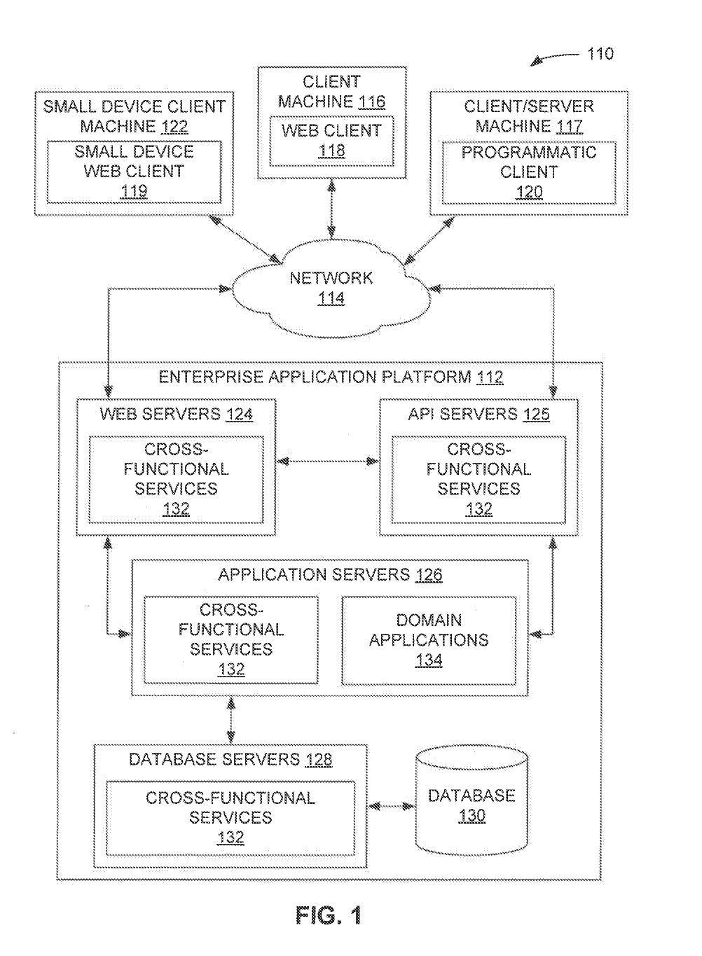

FIG. 1 is a network diagram depicting an example system 110, according to one exemplary embodiment, having a client-server architecture configured to perform the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the Internet Explorer browser developed by Microsoft Corporation of Redmond, Wash.), a small device client machine 122 with a small device web client 119 (e.g., a browser without a script engine) and a client/server machine 117 with a programmatic client 120.

Turning specifically to the enterprise application platform 112, web servers 124 and Application Program Interface (API) servers 125 are coupled to, and provide web and programmatic interfaces to, application servers 126. The application servers 126 are, in turn, shown to be coupled to one or more database servers 128 that may facilitate access to one or more databases 130. The web servers 124, Application Program Interface (API) servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third party and legacy applications with existing cross-functional services 132 and domain applications 134. Further, while the system 110 shown in FIG. 1 employs a client-server architecture, the present disclosure is of course not limited to such an architecture, and could equally well find application in a distributed, or peer-to-peer, architecture system.

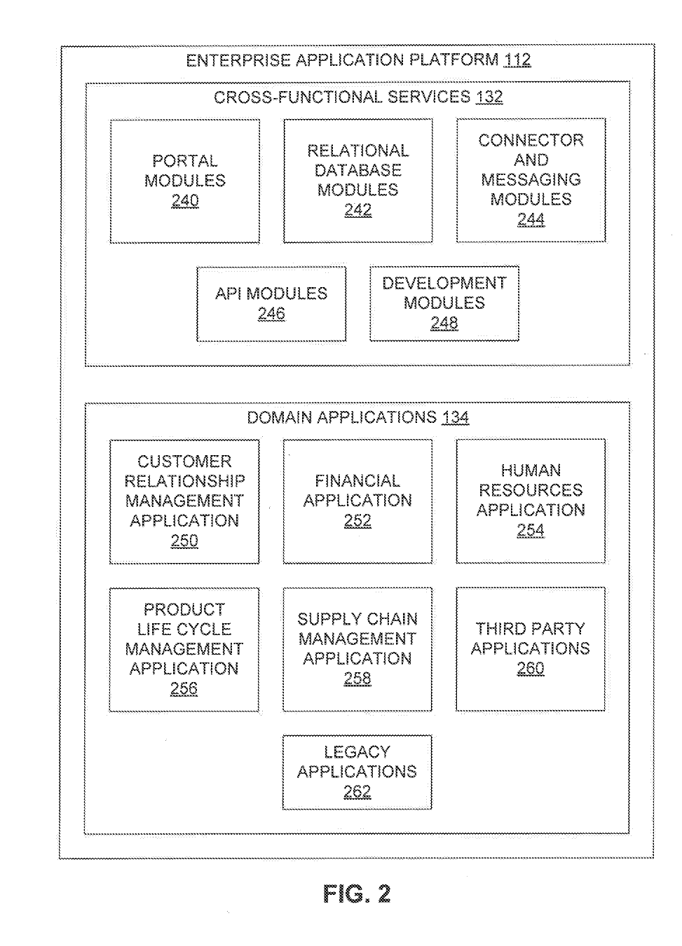

FIG. 2 is a block diagram illustrating example enterprise applications and services, such as those described herein, as embodied in the enterprise application platform 112, according to an exemplary embodiment. The enterprise application platform 112 includes cross-functional services 132 and domain applications 134. The cross-functional services 132 include portal modules 240, relational database modules 242, connector and messaging modules 244, Application Program Interface (API) modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java, J2EE, SAP's Advanced Business Application Programming Language (ABAP) and Web Dynpro, XML, JCA, JAAS, X.509, LDAP, WSDL, WSRR, SOAP, UDDI, and Microsoft .NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, SQL, SQLDBC, Oracle, MySQL, Unicode, and JDBC.

The connector and messaging modules 244 may enable communication across different types of messaging systems that are utilized by the cross-functional services 132 and,the domain applications 134 by providing a common messaging application processing interface. The connector and messaging modules 244 may enable asynchronous communication on the enterprise application platform 112.

The Application Program Interface (API) modules 246 may enable the development of service-based applications by exposing an interface to existing and new applications as services. Repositories may be included in the platform as a central place to find available services when building applications.

The development modules 248 may provide a development environment for the addition, integration, updating, and extension of software components on the enterprise application platform 112 without impacting existing cross-functional services 132 and domain applications 134.

Turning to the domain applications 134, the customer relationship management applications 250 may enable access to and facilitate collecting and storing of relevant personalized information from multiple data sources and business processes. Enterprise personnel that are tasked with developing a buyer into a long-term customer may utilize the customer relationship management applications 250 to provide assistance to the buyer throughout a customer engagement cycle.

Enterprise personnel may utilize the financial applications 252 and business processes to track and control financial transactions within the enterprise application platform 112. The financial applications 252 may facilitate the execution of operational, analytical, and collaborative tasks that are associated with financial management. Specifically, the financial applications 252 may enable the performance of tasks related to financial accountability, planning, forecasting, and managing the cost of finance.

The human resources applications 254 may be utilized by enterprise personal and business processes to manage, deploy, and track enterprise personnel. Specifically, the human resources applications 254 may enable the analysis of human resource issues and facilitate human resource decisions based on real-time information.

The product life cycle management applications 256 may enable the management of a product throughout the life cycle of the product. For example, the product life cycle management applications 256 may enable collaborative engineering, custom product development, project management, asset management, and quality management among business partners.

The supply chain management applications 258 may enable monitoring of performances that are observed in supply chains. The supply chain management applications 258 may facilitate adherence to production plans and on-time delivery of products and services.

The third-party applications 260, as well as legacy applications 262, may be integrated with domain applications 134 and utilize cross-functional services 132 on the enterprise application platform 112.

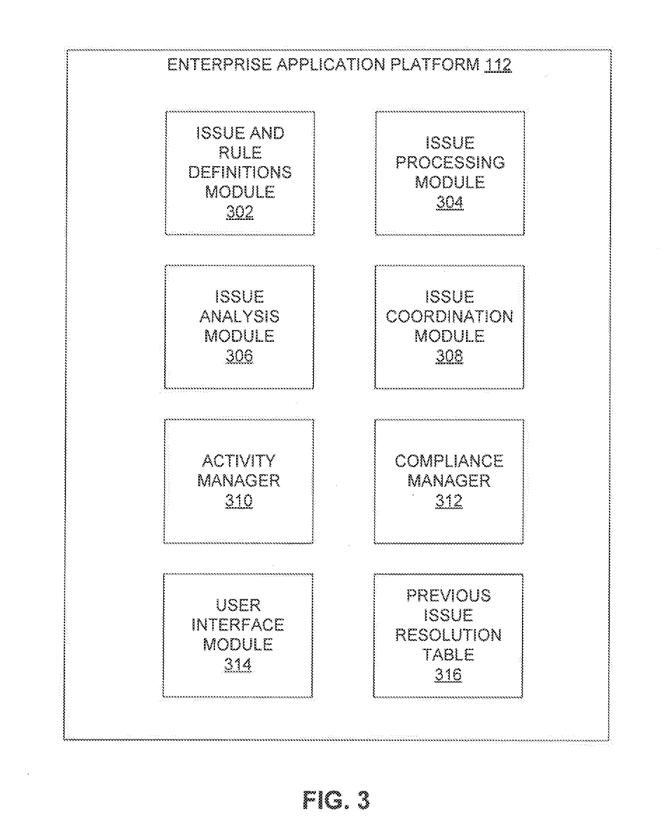

FIG. 3 is a block diagram of example applications and modules utilized in the enterprise application platform of FIG. 1 for issue processing. In some embodiments, the applications and modules of FIG. 3 process issues associated with any of the applications and services discussed herein with respect to FIGS. 1 and 2. An issue and rule definitions module 302 stores and manages various issues and rule definitions associated with processing the issues. The issue definitions include, for example, issue types, issue sources, issue handling techniques, relationships with other issues, and the like. The rule definitions include actions, questions, and other data used to resolve issues. The rule definitions are based on, for example, resolution of previous issues, anticipated issues, and expert recommendations for handling particular issues. The processing of issues and the application of the rules are discussed in greater detail herein.

An issue processing module 304 handles various functions associated with any number of issues. The issue processing module 304 may also monitor the handling of one or more issues until they are fully resolved. In some embodiments, the issue processing module 304 stores data associated with each issue, including what actions or operations were performed to resolve the issue. This data may be useful when processing similar types of issues in the future. An issue analysis module 306 performs various analysis operations related to one or more issues. In some embodiments, the issue analysis module 306 performs a contextual analysis of a particular issue. The issue analysis module 306 may identify one or more potential actions (or activities) to perform in an attempt to resolve the issue. As discussed herein, actions may include asking a question to obtain additional information about an issue, issuing a command or instruction to an application, and the like. In some embodiments, the issue analysis module 306 includes a rule engine that applies one or more rule definitions to the issue being analyzed to identify potential actions to perform in an attempt to resolve the issue.

An issue coordination module 308 aggregates data associated with multiple issues, such as descriptions of the issues, activities performed in an attempt to resolve the issue, and how the issue was successfully resolved. The issue coordination module 308 also shows relationships between various issues that have similar features or were resolved in similar manners. An activity manager 310 handles the triggering of various activities performed to resolve issues. For example, the activity manager 310 may identify a question to ask in an attempt to determine the cause or source of the issue. Alternatively, the activity manager 310 may implement or recommend a particular function in an attempt to resolve the issue. The activity manager 310 also monitors the performance of activities as well as the result (or outcome) of the activity. The activities performed, and the results of the activities, may be reported by the activity manager 310 to one or more systems or modules, such as the issue processing module 304 or the issue coordination module 308.

A compliance manager 312 monitors activities performed with respect to various issues and verifies that the activities comply with, for example, definitions contained in issue and rule definitions module 302. A user interface module 314 allows one or more users to interact with the various applications and modules shown in FIG. 3. For example, users may define or edit issue and rule definitions, implement one or more activities, review previous issue resolution activities, and the like. A previous issue resolution table 316 stores data related to the prior resolution of one or more issues. In some embodiments, the previous issue resolution table 316 is accessed by other modules and applications, such as the issue processing module 304 and the issue coordination module 308.

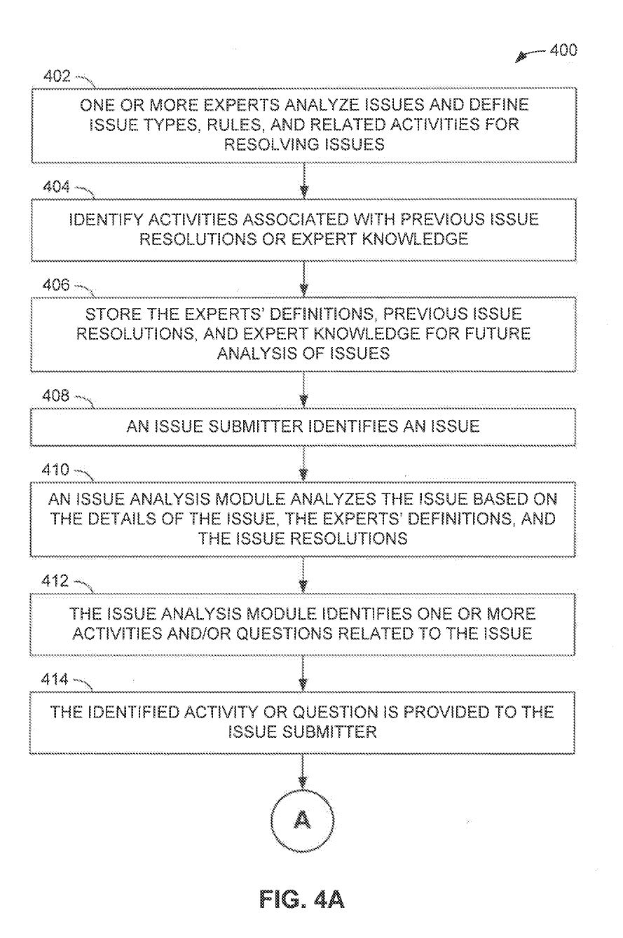

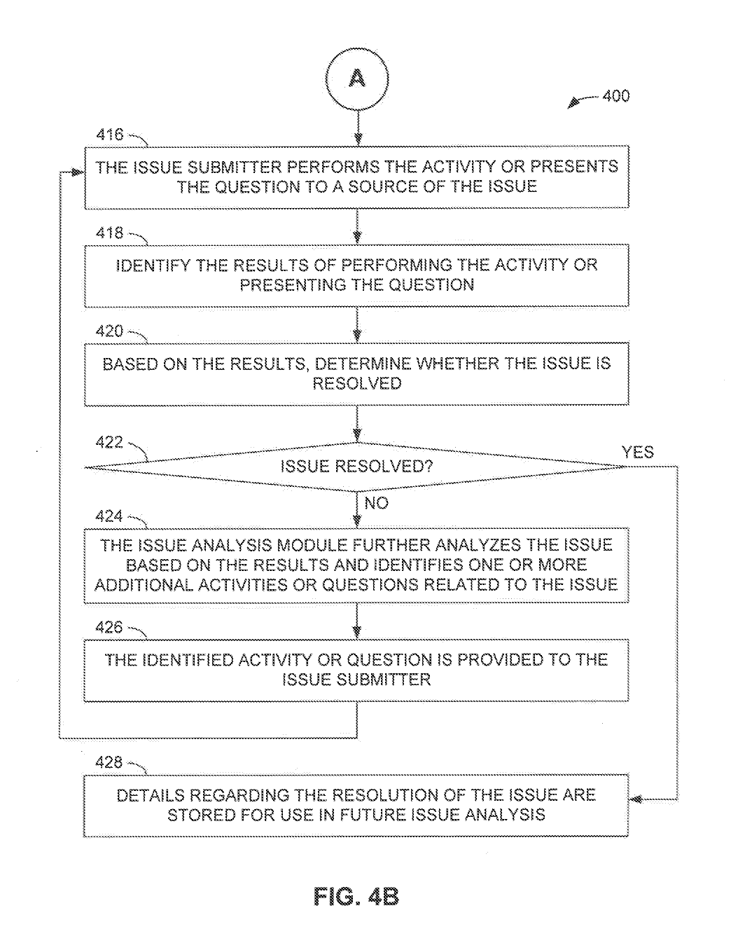

FIGS. 4A and 4B represent a flow diagram of an example method 400 of defining and applying rules related to one or more issues. In some embodiments, the method 400 is implemented using at least a portion of the applications and modules shown in FIG. 3. Initially, one or more experts (or other individuals) analyze issues and define issue types, rules, and related activities for resolving issues at 402. For example, a quality management expert may analyze various issues and make an initial determination regarding how to best handle those issues. Additionally, experts may identify one or more questions to ask regarding particular issues. These questions may identify specific details related to the issue that are useful in resolving the issue or useful in identifying additional questions to ask regarding the issue. The method 400 continues by identifying activities associated with previous issue resolutions or expert knowledge at 404. The experts' definitions, previous issue resolutions, and expert knowledge are stored for future analysis of issues at 406. For example, the previous issue resolution table 316 (FIG. 3) may store the previous issue resolutions and expert knowledge associated with multiple issues. Other data, such as experts' definitions, may be stored in other tables or databases (e.g., a table of issue types).

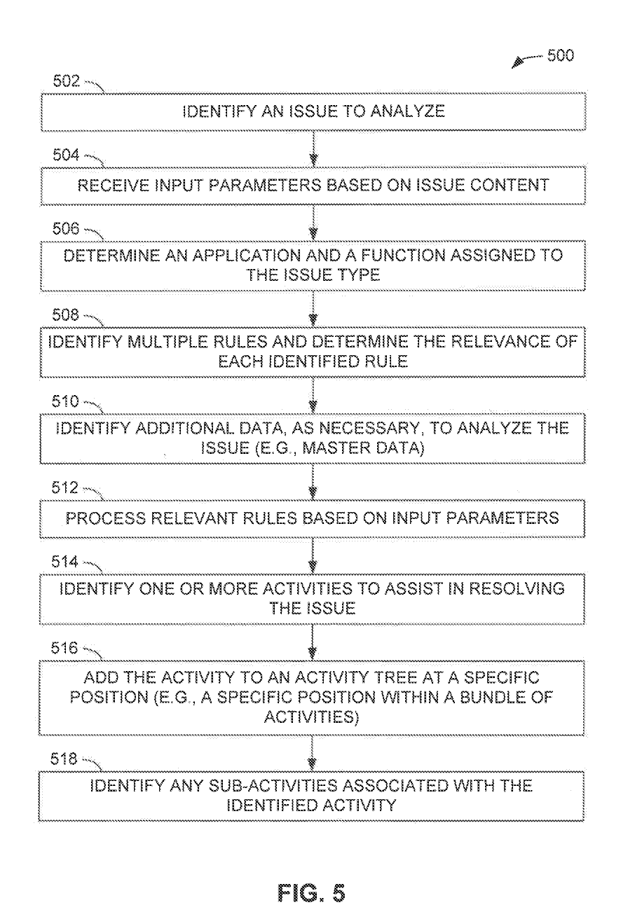

At some point, an issue submitter identifies an issue at 408. The issue submitter may be a person (e.g., a customer service agent or a system administrator), a system (e.g., the issue analysis module 306 (FIG. 3)), or an application (e.g., a software application, a process or a function). The method 400 continues as an issue analysis module analyzes the issue based on the details of the issue, the experts' definitions, and issue resolutions (which may be based on previous issue resolutions) at 410. Additionally, the issue analysis module identifies one or more activities and/or questions related to the issue at 412. For example, the identified activities may include suggestions to resolve the issue. The questions may include attempts to obtain additional details regarding the issue to better identify a solution to the issue. Additional details regarding the analysis of the issue are discussed with respect to FIG. 5.

After identifying one or more activities and/or questions related to the issue, the method 400 provides the identified activity or question to the issue submitter at 414. The issue submitter then performs the activity or presents the question to a source of the issue at 416. For example, the source of the issue may be a person with a problem or complaint, or a system/application that is not functioning properly. In some embodiments, the issue submitter facilitates performance of the activity or presentation of the question by another person, system or application. The method 400 continues by identifying the results of performing the activity or presenting the question at 418. Based on the identified results, the method determines whether the issue is resolved at 420. If the issue is resolved at 422, the details regarding the resolution of the issue are stored for use in future issue analysis at 428. For example, the details may include the resolution (such as “successful” or “not successful”) or other data associated with the issue, activities performed, and particular circumstances associated with the issue. In some embodiments, one or more rule definitions are updated based on the resolution of the issue. For example, if resolution of the issue was contrary to a particular rule definition, the rule may be modified or an exception to the rule may be noted for future reference.

If the issue is not resolved at 422, the issue analysis module further analyzes the issue based on the results and identifies one or more additional activities or questions related to the issue at 424. For example, as a result of the previous activity or question, the issue analysis module may identify additional details regarding the issue, identify additional experts' definitions or identify additional information regarding previous issue resolutions. The identified activity or question is then provided to the issue submitter at 426. The method 400 returns to 416, where the issue submitter performs the identified activity or presents the question in a further attempt to resolve the issue. This process continues until the issue is resolved or the issue is forwarded to another issue submitter (or another system/process) for handling. In some embodiments, a particular issue is forwarded to an expert if it cannot be resolved within a particular period of time or a particular number of resolution activities.

FIG. 5 is a flow diagram of an example method 500 of analyzing an issue. In some embodiments, the method 500 is implemented using at least a portion of the applications and modules shown in FIG. 3. In a particular implementation, the method 500 is performed by issue analysis module 306 (FIG. 3). Initially, method 500 identifies an issue to analyze at 502 and receives various input parameters based on the issue content at 504. Example input parameters include material, customer identity, a defect code, and an issue priority.

The method 500 continues by determining an application and a function assigned to the issue type at 506. The application and function address particular types of issue resolutions and expert definitions. For example, issue resolutions for a customer complaint may be different than issue resolutions for an internal issue. The method 500 then identifies multiple rules and determines the relevance of each identified rule at 508. In some embodiments, the relevance is determined, at least in part, by one or more input parameters. Further, the method 500 identifies additional data, as necessary to analyze the issue at 510. In some embodiments, this additional data is referred to as “master data.” For example, if an issue is related to a material, it may be important to identify one or more base units (or base components) associated with the material. In this example, a rule may call a function that retrieves additional information related to the material.

The method 500 continues by processing the relevant rules based on the input parameters and any additional data related to the issue at 512. Based on the processing of the rules, the method 500 identifies one or more activities to assist in resolving the issue at 514. In some embodiments, these identified activities are added to the issue as a proposed activity. A user can then evaluate a list of proposed activities and decide whether to implement one or more of the proposed activities. In some implementations, the user may choose not to implement any of the proposed activities.

The identified activity is then added to an activity tree at a specific position at 516, such as a specific position within a bundle of activities. The method 500 then identifies any sub-activities associated with the identified activity at 518. In some embodiments, the activity tree includes a hierarchy of activities and associated sub-activities. For example, an activity “check power supply” may have multiple sub-activities: “check fuse at electric generator,” “check connection between cable and electric generator,” and “check connection between cable and electricity consumer.” A particular activity tree may be associated with specific types of issues or categories of issues.

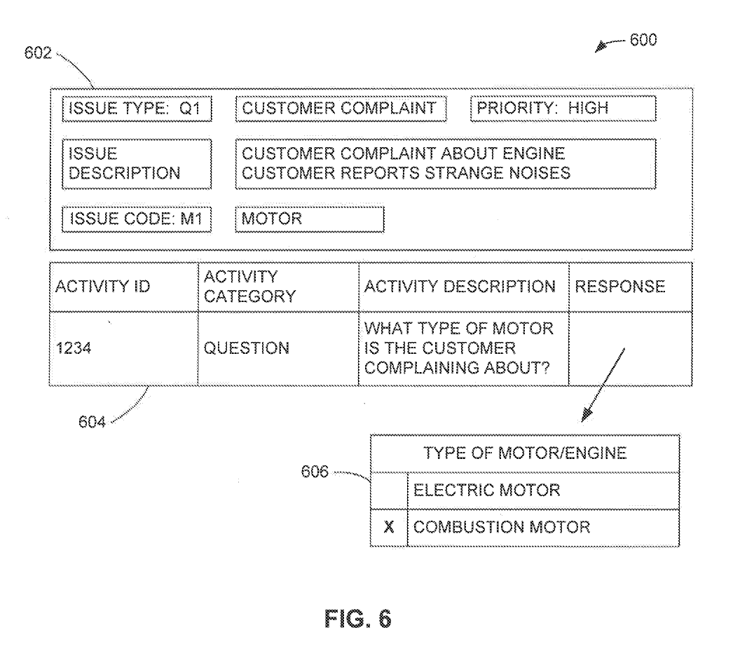

FIGS. 6-8 illustrate example user interfaces enabling a display of and interaction with, various aspects of an issue processing system. In FIG. 6, an example user interface 600 includes various information related to an issue. In this example, information describing the issue is shown in the top portion 602 of the user interface 600. As shown, the issue is a customer complaint related to an engine making “strange noises.” The issue has an associated type “Q1,” which is a customer complaint, and an associated priority of “High.” The issue also has a related issue code “M1,” which indicates the issue is related to a motor. In some embodiments, the top portion 602 of the user interface 600 is presented to, for example, a customer service agent upon receipt of a customer complaint or other issue.

A lower portion 604 of the user interface 600 displays a particular activity or action to be performed in response to receiving the issue. This activity or action is determined, for example, using the methods discussed herein. In the example of FIG. 6, the activity has an associated Activity ID of “1234” and an associated Activity Category of “Question.” The Activity Description includes an instruction to determine the type of motor about which the customer is complaining. This activity can be performed, for example, by a customer service agent asking the customer regarding the motor. Alternatively, the customer service agent may look up the type of product purchased by the customer to determine the type of motor in the customer's product. A data entry portion 606 is also presented to the customer service agent. The data entry portion 606 allows the customer service agent to select the type of motor associated with the issue. In this example, the customer service agent has selected “Combustion Motor” as the type of motor related to the complaint. In some embodiments, the data entry portion 606 includes a list of all possible responses to the activity identified in the lower portion 604 of the user interface 600. In other embodiments, the data entry portion 606 includes a data entry portion in which the customer service agent can enter information in response to the identified activity.

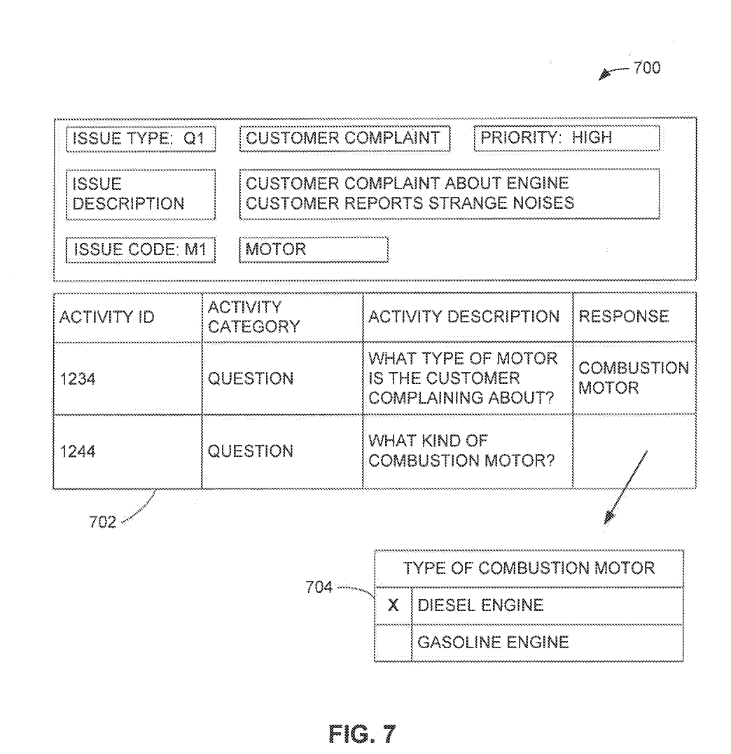

In FIG. 7, an example user interface 700 illustrates additional information related to an issue. In this example, a lower portion 702 of the user interface 700 illustrates another activity or action to be performed in response to receiving the response (Combustion Motor) to the first activity. This additional activity is determined, for example, using the methods discussed herein. The additional activity is another question that requests further details regarding the type of combustion motor. A data entry portion 704 is presented to the customer service agent. The data entry portion 704 allows the customer service agent to select the type of combustion motor associated with the issue (e.g., a diesel engine or a gasoline engine). In this example, the customer service agent has determined that the combustion motor is a diesel engine.

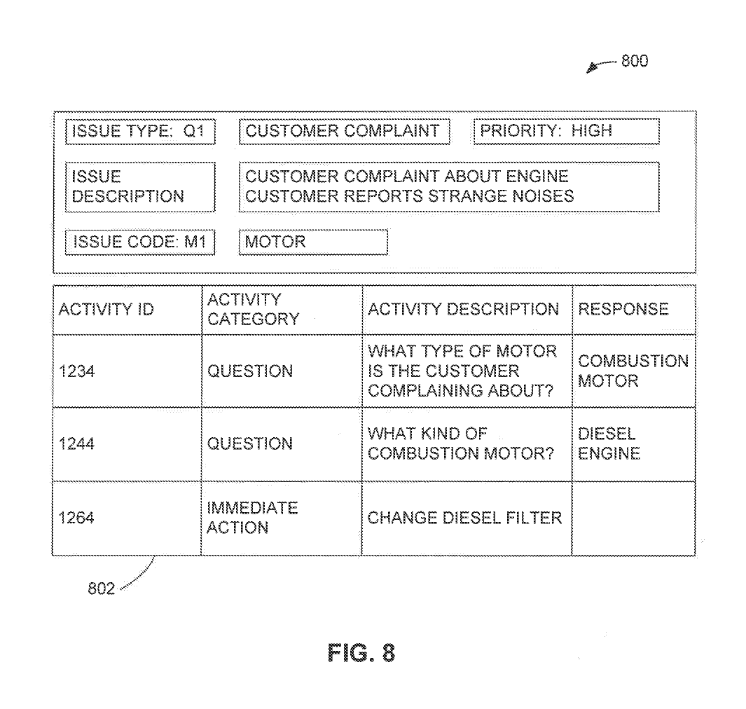

In FIG. 8, an example user interface 800 illustrates additional information related to an issue. In this example, a lower portion 802 of the user interface 800 illustrates an action to be performed that is expected to resolve the issue. As shown in FIG. 8, this action includes changing a diesel filter on the diesel engine. If changing the diesel filter does not resolve the issue, additional actions or activities may be recommended to obtain additional data to further analyze the issue.

The sequence of activities shown in FIGS. 6-8 represent an example of an activity tree discussed herein. In this example, FIG. 6 illustrates a first activity in the activity tree (i.e., asking a question about the type of motor related to the complaint (electric or combustion)). FIG. 7 illustrates a sub-activity associated with the first activity mentioned above. This sub-activity is a question determining they type of combustion motor (diesel or gasoline). A further sub-activity (changing the diesel filter) is illustrated in FIG. 8. Any number of activities and related sub-activities may be included in an activity tree.

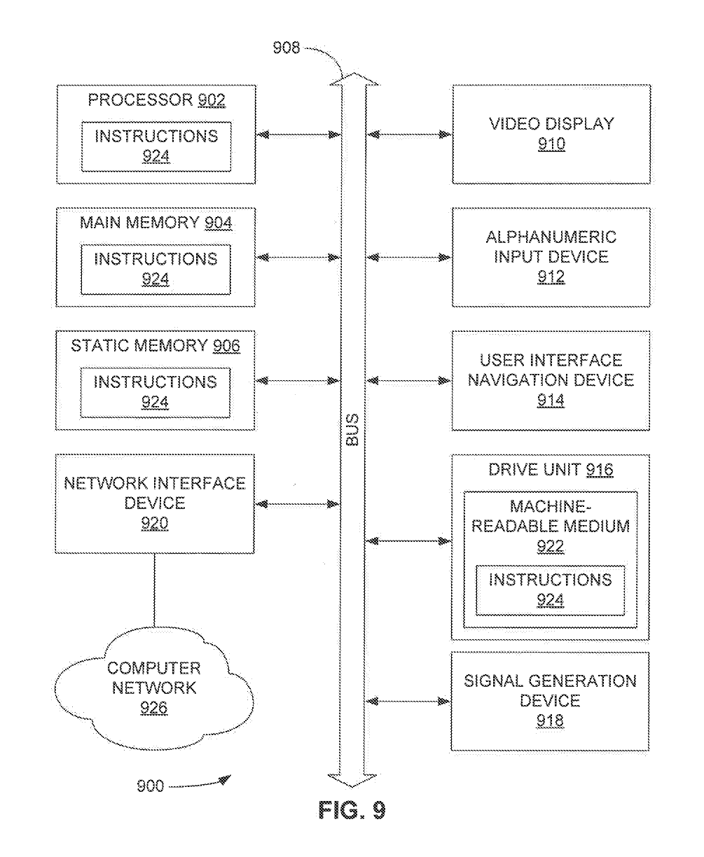

FIG. 9 depicts a block diagram of a machine in the example form of a processing system 900 within which may be executed a set of instructions for causing the machine to perform any one or more of the methodologies discussed herein. In alternative embodiments, the machine operates as a standalone device or may be connected (for example, networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 900 includes a processor 902 (for example, a central processing unit (CPU), a graphics processing unit (GPU), or both), a main memory 904 (for example, random access memory), and static memory 906 (for example, static random-access memory), which communicate with each other via bus 908. The processing system 900 may further include video display unit 910 (for example, a plasma display, a liquid crystal display (LCD), or a cathode ray tube (CRT)). The processing system 900 also includes an alphanumeric input device 912 (for example, a keyboard), a user interface (UI) navigation device 914 (for example, a mouse), a disk drive unit 916, a signal generation device 918 (for example, a speaker), and a network interface device 920.

The disk drive unit 916 (a type of non-volatile memory storage) includes a machine-readable medium 922 on which is stored one or more sets of data structures and instructions 924 (for example, software) embodying or utilized by any one or more of the methodologies or functions described herein. The data structures and instructions 924 may also reside, completely or at least partially, within the main memory 904, the static memory 906, and/or within the processor 902 during execution thereof by processing system 900, with the main memory 904 and processor 902 also constituting machine-readable, tangible media.

The data structures and instructions 924 may further be transmitted or received over a computer network 926 via network interface device 920 utilizing any one of a number of well-known transfer protocols (for example, HyperText Transfer Protocol (HTTP)).

Certain embodiments are described herein as including logic or a number of components, modules, or mechanisms. Modules may constitute either software modules (for example, code embodied on a machine-readable medium or in a transmission signal) or hardware modules. A hardware module is a tangible unit capable of performing certain operations and may be configured or arranged in a certain manner. In example embodiments, one or more computer systems (for example, the processing system 900) or one or more hardware modules of a computer system (for example, a processor 902 or a group of processors) may be configured by software (for example, an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 902 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (for example, hardwired) or temporarily configured (for example, programmed) to operate in a certain manner and/or to perform certain operations described herein. Considering embodiments in which hardware modules are temporarily configured (for example, programmed), each of the hardware modules need not be configured or instantiated at any one instance in time. For example, where the hardware modules include a general-purpose processor 902 that is configured using software, the general-purpose processor 902 may be configured as respective different hardware modules at different times. Software may accordingly configure a processor 902, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 902 that are temporarily configured (for example, by software) or permanently configured to perform the relevant operations. Whether temporarily or permanently configured, such processors 902 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 902 or processor-implemented modules. The performance of certain of the operations may be distributed among the one or more processors 902, not only residing within a single machine but deployed across a number of machines. In some example embodiments, the processors 902 may be located in a single location (for example, within a home environment, within an office environment, or as a server farm), while in other embodiments, the processors 902 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method comprising:
identifying an issue;
accessing a plurality of rules associated with resolving the issue;
accessing data associated with previous issue resolutions;
analyzing the identified issue based on the rules and the data associated with previous issue resolutions;
determining, using one or more processors, a first activity to perform based on the analyzing of the identified issue;
identifying results of performing the first activity;
determining whether the first activity resolved the issue; and
responsive to determining that the first activity did not resolve the issue:
accessing an activity tree to identify at least one sub-activity associated with the first activity;
further analyzing the identified issue based on the rules, the data associated with previous issue resolutions, the results of performing the first activity, and the at least one sub-activity; and
determining a second activity to perform based on the further analyzing of the identified issue.

2. The method of claim 1, the first activity and the second activity being questions associated with the identified issue.

3. The method of claim 1, the first activity and the second activity being actions capable of being performed by an issue submitter.

4. The method of claim 1, further comprising instructing an issue submitter to perform the first activity.

5. The method of claim 1, wherein the identified issue is received by a system from a user.

6. The method of claim 1, further comprising updating data associated with previous issue resolutions based on the results of performing the first activity.

7. The method of claim 1, further comprising:
performing the second activity;
identifying results of performing the second activity;
determining whether the second activity resolved the issue; and
responsive to determining that the second activity did not resolve the issue, further analyzing the identified issue based on the rules, the data associated with previous issue resolutions, and the results of performing the second activity to determine a third activity to perform.

8. The method of claim 7, further comprising updating data associated with previous issue resolutions based on the results of performing the first activity and the results of performing the second activity.

9. The method of claim 1, wherein the issue has an associated issue type determined by an issue submitter.

10. The method of claim 1, the identifying of the issue including identifying issue details provided by an issue submitter.

11. The method of claim 1, further comprising implementing the first activity responsive to determining the first activity.

12. A system comprising:
at least one processor; and
modules comprising instructions that are executable by the at least one processor, the modules comprising:
an issue processing module configured to identify an issue;
an activity manager configured to identify results of performing activities; and
an issue analysis module configured to access rules associated with resolving the issue and access data associated with previous issue resolutions, the issue analysis module further configured to analyze the identified issue based on the rules and the data associated with previous issue resolutions, the issue analysis module further configured to determine a first activity to perform based on the analyzing of the identified issue and to determine whether the first activity resolved the issue, and responsive to determining that the first activity did not resolve the issue, the issue analysis module further configured to:
further analyze the identified issue based on the rules, the data associated with previous issue resolutions, and results of performing the first activity; and
determining a second activity to perform based on the further analyzing of the identified issue.

13. The system of claim 12, further comprising a previous issue resolution table configured to store the data associated with previous issue resolutions.

14. The system of claim 13, the activity manager further configured to update the previous issue resolution table based on the results of performing the first activity.

15. The system of claim 12, the first and second activities including actions capable of being performed by an issue submitter.

16. The system of claim 12, the first and second activities including questions associated with the identified issue.

17. The system of claim 12, the activity manager further configured to instruct an issue submitter to perform the first activity.

18. The system of claim 12, the issue analysis module further configured to access an activity tree to identify at least one sub-activity associated with the first activity.

19. A non-transitory computer-readable storage medium comprising instructions that, when executed by at least one processor of a machine, cause the machine to perform operations comprising:
identifying an issue;
accessing rules associated with resolving the issue;
accessing data associated with previous issue resolutions;
analyzing the identified issue based on the rules and the data associated with previous issue resolutions;
determining a first activity to perform based on the analyzing of the identified issue;
identifying results of performing the first activity;
determining whether the first activity resolved the issue; and
responsive to determining that the first activity did not resolve the issue:
further analyzing the identified issue based on the rules, the data associated with previous issue resolutions, and the results of performing the first activity; and
determining a second activity to perform based on the further analyzing of the identified issue.

20. The non-transitory computer-readable storage medium of claim 19, the machine further to perform operations comprising updating data associated with previous issue resolutions based on the results of performing the first activity.
